(19) United States
(12) Patent Application Publication
(10) Pub. No.: US 2003/0120511 A1
(43) Pub. Date: Jun. 26, 2003

(54) Health plan decision support system and method

(76) Inventor: Mark W. Legnini, Washington, DC (US)

Correspondence Address: MARK J. YOUNG, 50 N. LAURA STREET, SUITE 3300, JACKSONVILLE, FL, 32202, US

(21) Appl. No.: 10/023,301

(22) Filed: Dec. 20, 2001

(51) Int. Cl. G06F 17/60

(52) U.S. Cl. 705/2

(57) ABSTRACT

A system and method for facilitating the selection of an available health plan or health care provider employs a series of straightforward questions, prompting a user for the relative importance (e.g., above average, average, not important) of various plan attributes according to the user's own preferences. A database includes information concerning available plans, including costs, benefits available and ratings for each attribute. Based on user input, available plans are cumulatively scored according to the plans' ratings for each attribute.

### GOVERNMENT LICENSE RIGHTS

The U.S. Government may have a paid-up license in this invention and the right in limited circumstances to require the patent owner to license others on reasonable terms as provided for by the terms of contract No. 290-98-0024 awarded by the Agency for Health Care Policy and Research.

### FIELD OF THE INVENTION

The present invention relates generally to health plans and health care providers. More particularly, the present invention relates to a system and method for facilitating the selection of a health plan or health care provider from a group of available health plans or providers according to relative priorities expressed by a user for various plan or provider attributes.

### BACKGROUND

Today there are many health plans and providers from which consumers may choose. While some people may have no choice in selecting their health plan, those that do may face the daunting task of evaluating and comparing available plans based on various, often voluminous and esoteric, data. Price and physician choice are the two most frequent decision-making criteria used when choosing a health plan, but other criteria such as health plan enrollee satisfaction, the quality of care provided, whether the plan is recognized by a national accrediting body, and the out-of-pocket cost implications of different packages, are also important.

To make an informed decision, consumers need an easy-to-use decision-making system and methodology for weighing several different kinds of information pertaining to available health plans and providers. In the absence of such a tool, consumers will often choose a plan based on price and ignore other important attributes, especially if they have no reason to change physicians. Any attempt to improve the decision-making process and encourage consumers to weigh other plan attributes requires a decision support tool.

### SUMMARY

The present invention provides a system and method for facilitating the selection of an available health plan or health care provider. A database includes information concerning available plans and providers, including costs, benefits available and performance measures. Using a series of straightforward questions, the system prompts a user for the relative importance (e.g., above average, average, not important) of various plan or provider attributes according to the user's own preferences and circumstances. The system scores and compares each health plan or provider according to its rating for each attribute and the importance of the attribute to the user.

An object of the present invention is to provide a system and method for facilitating the selection of an available health plan or health care provider based on a user's responses to a series of straightforward questions concerning the relative importance of various plan or provider attributes.

Another object of the present invention is to provide a system and method for facilitating the selection of an available health plan or health care provider based on scores earned by each available plan or provider according to a user's responses to a series of straightforward questions concerning the relative importance of various plan or provider attributes.

Yet another object of the present invention is to provide a system and method for facilitating the selection of an available health plan or health care provider that presents a user with various attributes upon which a plan or provider may be scored.

A further object of the present invention is to provide a system and method for facilitating the selection of an available health plan or health care provider according to various plan or provider attributes that includes a database of ratings for each attribute for each available health plan or health care provider.

### DRAWINGS

These and other features, aspects and advantages of the present invention will become better understood with reference to the following description, appended claims, and accompanying drawings, where:

FIG. 1 conceptually depicts a computer system for implementing a system and methodology to facilitate selecting a health plan or health care provider in accordance with a preferred implementation of the present invention;

FIG. 2 is a flowchart conceptually depicting steps of a method for facilitating the selection of a health plan or health care provider in accordance with a preferred implementation of the present invention;

FIG. 3 is a diagram that illustrates an introduction step in accordance with a preferred implementation of the present invention;

FIG. 4 is a diagram that illustrates an assessment of eligibility and dependants in accordance with a preferred implementation of the present invention;

FIG. 5 is a diagram that illustrates a step of providing links to information pertaining to available plans in accordance with a preferred implementation of the present invention;

FIG. 6 is a diagram that illustrates a step of ranking the relative importance of various plan attributes in accordance with a preferred implementation of the present invention;

FIG. 7 is a diagram that illustrates two questions pertaining to plan attributes along with a list of available plans in accordance with a preferred implementation of the present invention;

FIG. 8 is a diagram that illustrates two questions pertaining to plan attributes along with a list of available plans that have been cumulatively scored and sorted in accordance with a preferred implementation of the present invention;

FIG. 9 is a diagram that illustrates two questions pertaining to plan attributes along with a list of available plans that have been cumulatively scored and sorted in accordance with a preferred implementation of the present invention;

FIG. 10 is a diagram that illustrates three questions pertaining to plan attributes along with a list of available plans that have been cumulatively scored and sorted in accordance with a preferred implementation of the present invention;

FIG. 11 is a diagram that illustrates one question pertaining to a plan attribute along with a list of available plans that have been cumulatively scored and sorted in accordance with a preferred implementation of the present invention;

FIG. 12 is a diagram that illustrates the step of selecting plans to compare in detail from a list of available plans that have been cumulatively scored and sorted in accordance with a preferred implementation of the present invention;

FIG. 13 is a diagram that displays a comparison of selected available plans, including an icon for initiating a comparison of co-payments, in accordance with a preferred implementation of the present invention;

FIG. 14 is a diagram illustrating the step of collecting information needed to estimate co-payments for plans being compared in accordance with a preferred implementation of the present invention;

FIG. 15 is a diagram that illustrates a comparison of selected plans, including a comparison of co-payments, in accordance with a preferred implementation of the present invention;

FIG. 16 is a diagram that illustrates a survey step in accordance with a preferred implementation of the present invention; and

FIG. 17 is a diagram that illustrates the step of providing a link to an online enrollment process in accordance with a preferred implementation of the present invention.

### DETAILED DESCRIPTION

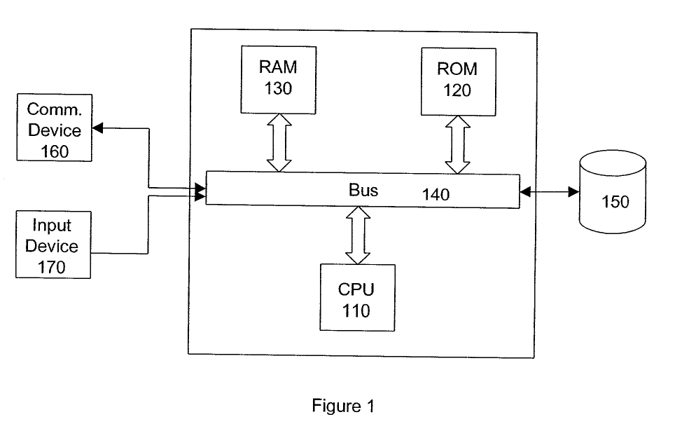

FIG. 1 conceptually shows an exemplary computer system for implementing a system and methodology to facilitate selecting a health plan or health care provider in accordance with a preferred implementation of the present invention. The computer system includes a bus 140 for communicating information, a central processing unit (CPU) 110, a read only memory (ROM) 120, random access memory (RAM) 130, a storage device 150, a communications device 160 and an input device 170. The storage device may include a hard disk, CD-ROM drive, tape drive, memory and/or other mass storage equipment. These elements are typically included in most computer systems and particularly computer servers, and the aforementioned system is intended to represent a broad category of systems capable of being programmed to perform the methodology in accordance with a preferred implementation of the present invention. Of course, the system may include fewer, different and/or additional elements, provided it is capable of performing the method of facilitating the selection of a health plan or health care provider in accordance with the present invention. For example, the system may include multiple CPUs, a display device, and various input and output devices. Additionally, the system may alone perform the methodology or operate in a distributed environment to perform the method in accordance with a preferred implementation of the present invention. A user may access the computer system directly using an input device or remotely via a dial-up or network connection. In a preferred embodiment, the system includes a series of interactive web pages accessible by users via an intranet or the Internet using conventional web page access means.

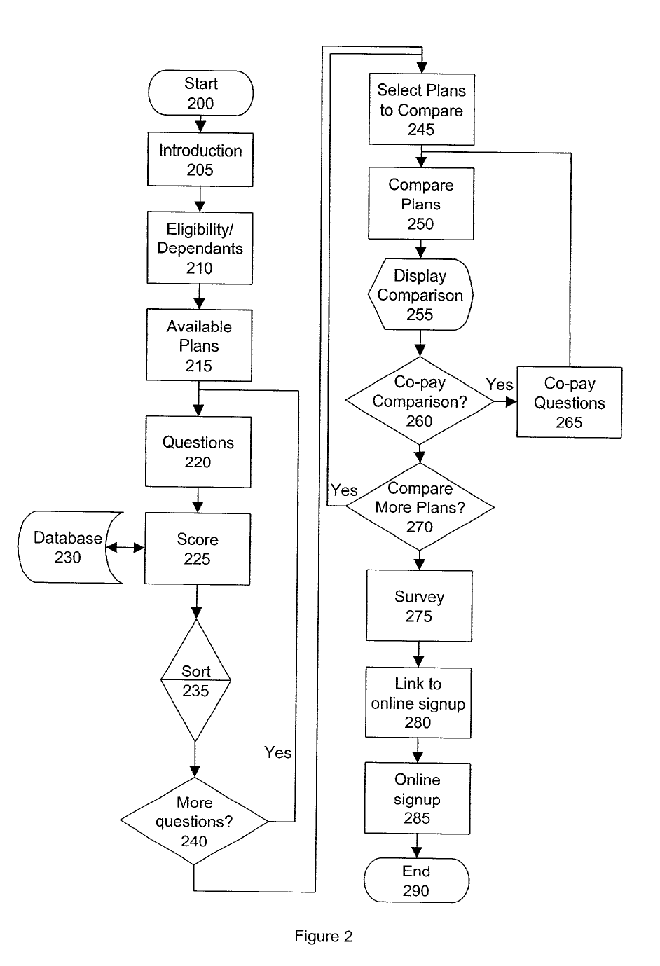

FIG. 2 shows a flowchart that conceptually depicts steps of a method for facilitating the selection of a health plan or health care provider in accordance with a preferred implementation of the present invention. While the flowchart and the following description focus primarily on selecting a health plan based on health plan attributes, the same process applies to the selection of a health care provider (e.g., a physician or hospital) based on provider attributes and comes within the scope of the present invention. The steps are presented in a logical order, though many other orderings are possible and come within the scope of the present invention.

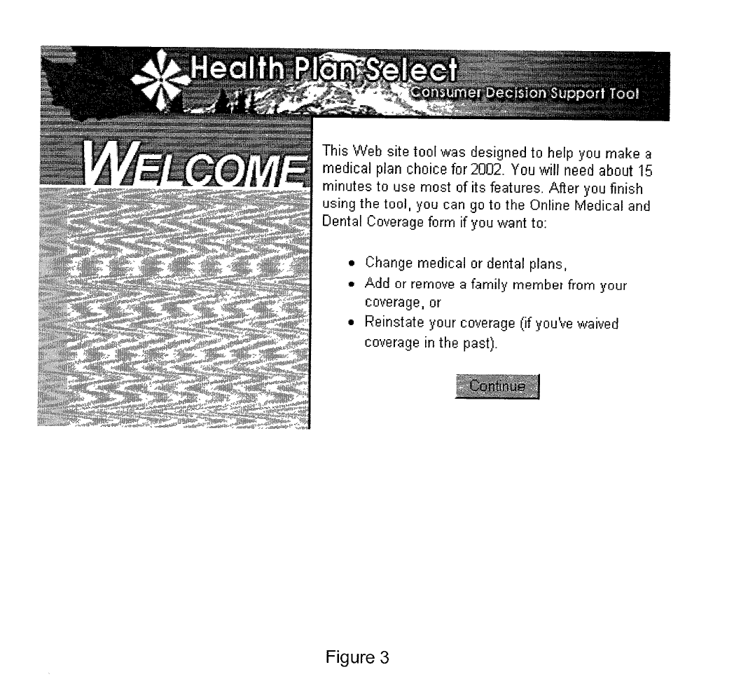

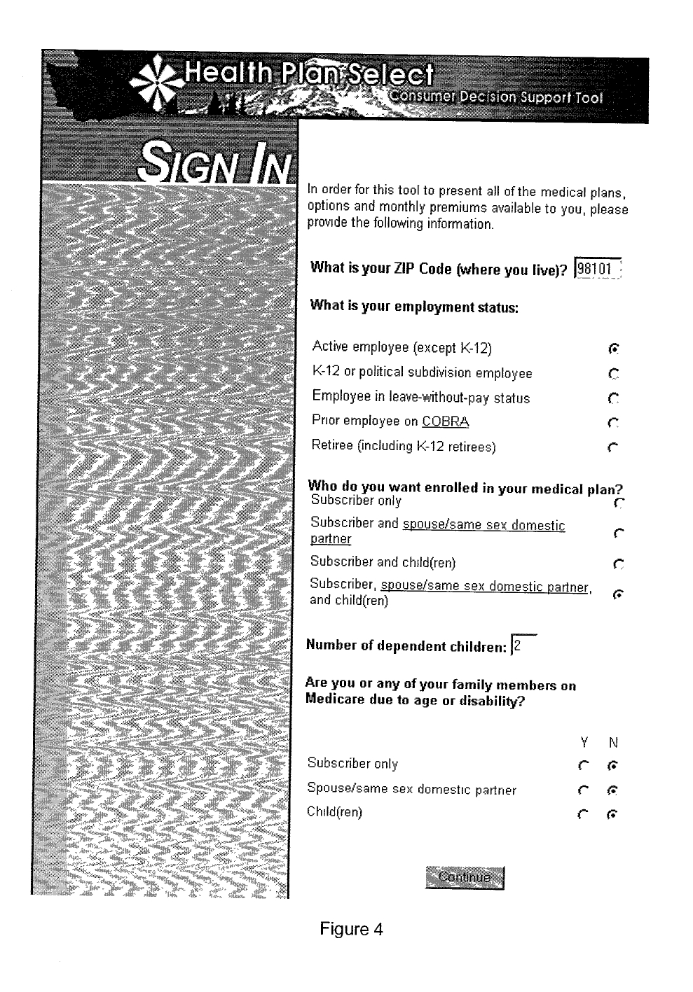

Referring to FIG. 2, an introduction step 205 preferably provides a user information pertaining to the plan selection process, such as an objective and estimated time required to proceed through the steps of the process. The introduction step may also provide a link to a privacy policy and a user selectable icon to proceed to the next step of the process, as illustrated in FIG. 3. After the introduction, information concerning eligibility and dependants are preferably gathered 210. The information, which may include employment status, disability information and information concerning covered individuals, as illustrated in FIG. 4, may be used to exclude plans for which the user is ineligible or that do not offer the required coverage. Again, a user may select an icon to proceed to the next step of the process. Preferably, each step of the process that displays information for a user or requires a user to provide input includes a user selectable icon to proceed to the next step of the process.

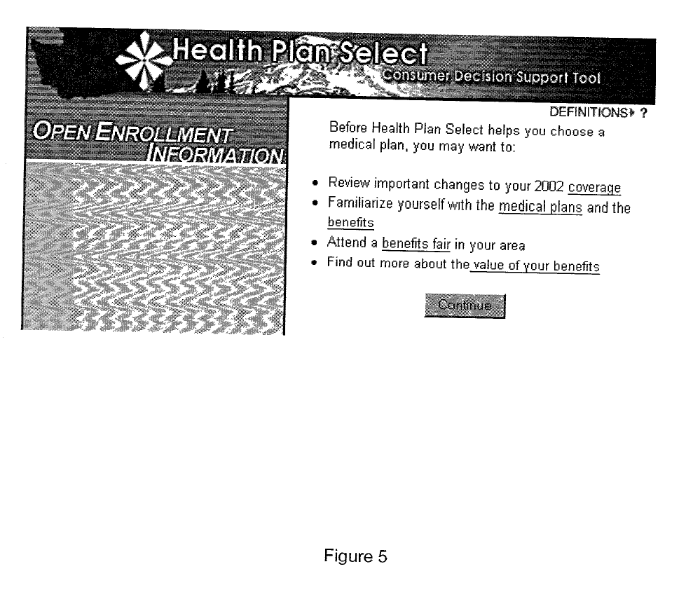

Next, links to information concerning the available plans may be provided, as in step 215. The links may address information concerning each available plan and changes to available coverage from the previous year, as in FIG. 5.

In a non-preferred implementation, before presenting questions to facilitate a comparison of plans, the method may include the step of prompting a user to exclude certain plans or include all plans. This step may allow a user to exclude a specific plan, specific types of plans (e.g., Preferred Provider Organization [“PPO”] plans) or any available plans. Exclusion may be warranted to accommodate a user's preferences or to eliminate plans for which incomplete data is available. For example, because of differences between certain plans, and because not all quality measures may be available for certain plans, it may not be considered meaningful to compare some plans in some areas. If all available plans are included in the analysis, the plans will preferably be compared to each other using only those attributes for which a rating exists for each plan. To illustrate, a plan may lack ratings for such attributes as breast cancer screening, cervical cancer screening, prenatal care, postpartum care and childhood immunization services. Ratings for such attributes may be available for all other available plans. In such a case, if the first plan is excluded from the analysis all other available plans may be compared based on their ratings for such attributes. However, if the first plan is included in the analysis, the available plans might not be compared based on their ratings for such attributes. In either case, all information on all plans (even excluded plans) may be made available for review and comparison at the comparison step of the process.

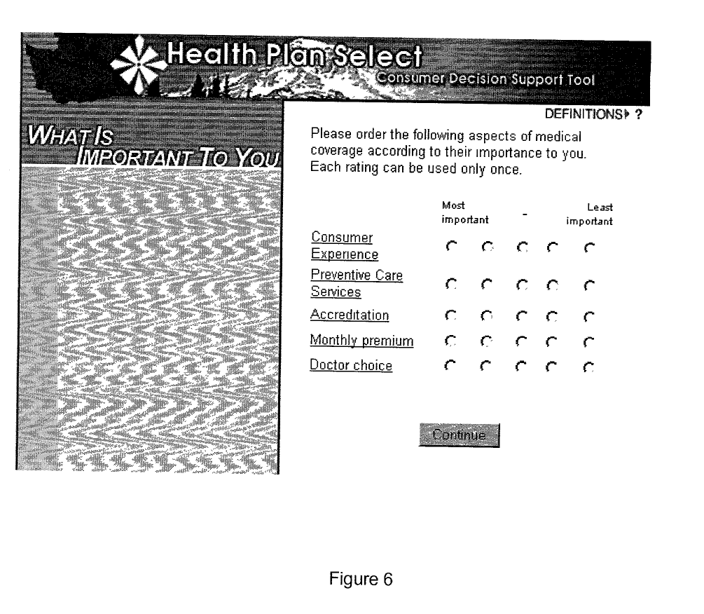

A preferred implementation of the methodology of the present invention may also include a step of ranking various plan attributes according to the relative importance of the attributes to the user, as shown in FIG. 6. The rankings may be used for demographics, to evaluate the user's opinions versus actual responses to individual questions in each category of plan attribute, or to decide the order in which questions pertaining to the attributes are presented.

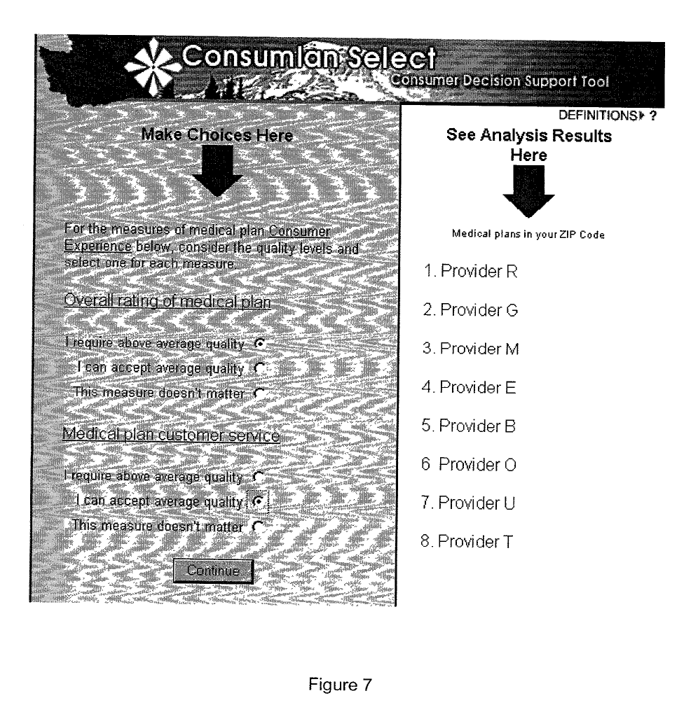

Next, the user is preferably presented with a series of questions or inquiries concerning plan attributes, as in steps 220 to 240. All questions may be presented to the user on a single screen, through which the user may scroll to enter responses. Alternatively, the questions may be divided among a series of screens to avoid scrolling. For example each screen may include up to three questions, as shown in FIGS. 7 through 11. The questions should be easy for a layperson to understand and may include links (i.e., hyperlinks) to detailed explanations (including definitions of terms and sources of information), as also shown in FIGS. 7 through 11.

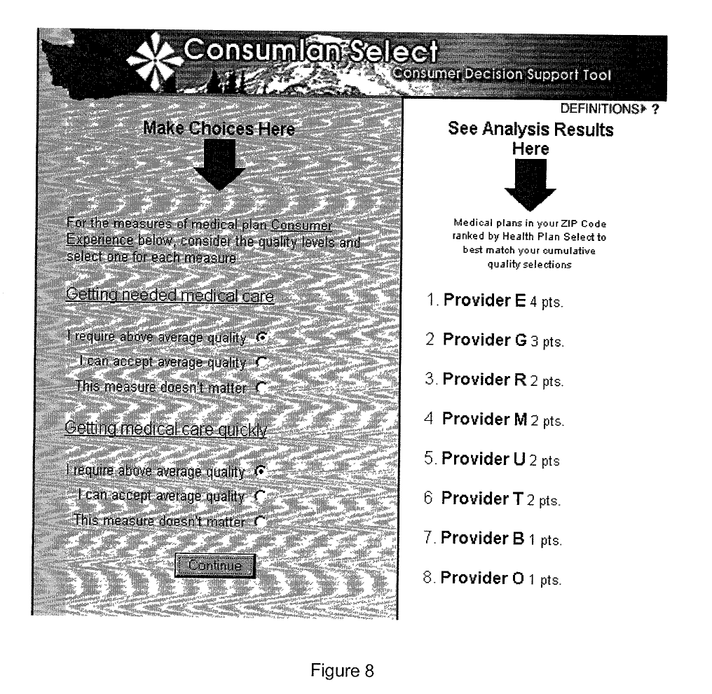

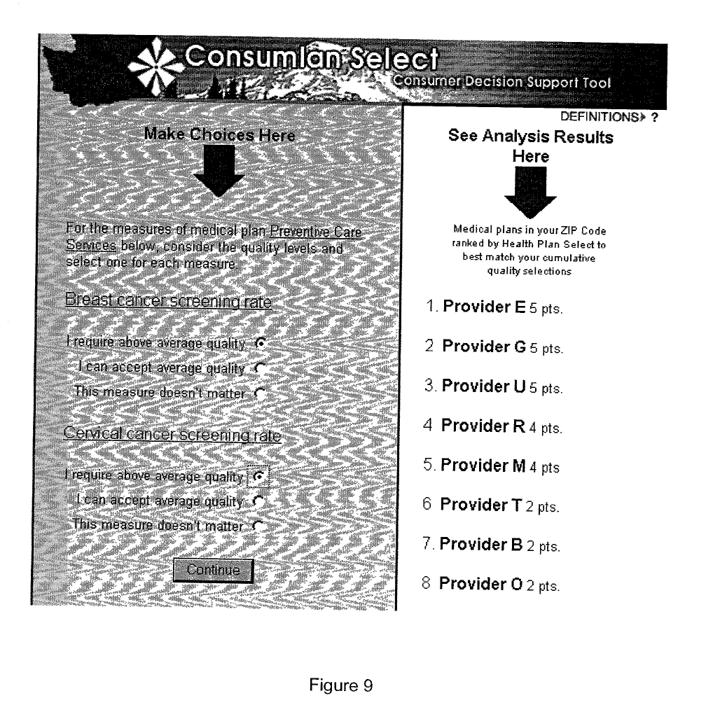

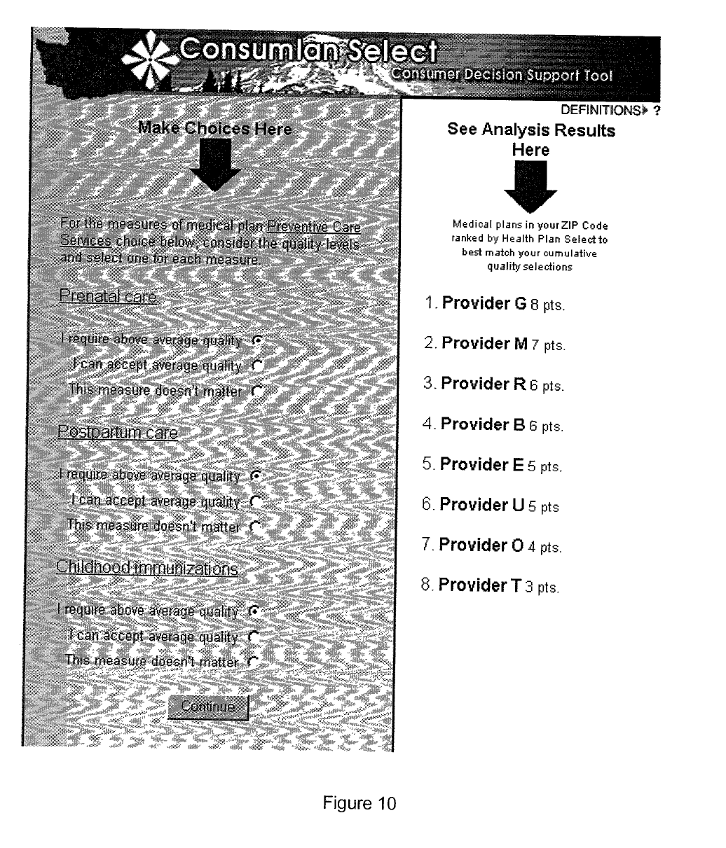

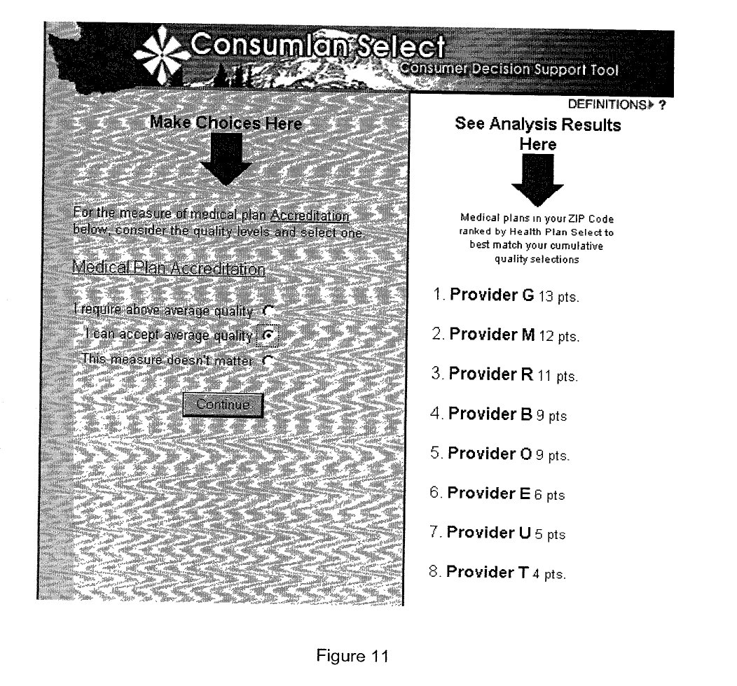

Preferably, the questions prompt the user for the relative importance of referenced attributes (also known as “measures”) relating to issues of quality, such as overall ratings, customer service, accreditation and preventive and screening services covered. To illustrate, a user may be asked what level of quality the user requires for the following: the overall rating of a medical plan and medical plan customer service, as in FIG. 7; getting needed medical care and getting medical care quickly, as in FIG. 8; breast cancer and cervical cancer screening rates as in FIG. 9, prenatal and portpartum care, as well as childhood immunizations, as in FIG. 10; and accreditation as in FIG. 11. Other areas of inquiry may include other preventive care services and other rated characteristics of plans. Possible answers for each inquiry may include choices representative of the relative importance of the subject attribute to the user, such as: “I require above average quality,” “I can accept average quality” or “This measure doesn't matter.” More answer choices may be provide to further distinguish the available plans.

The inquiries facilitate the selection of a health care plan by individuals having a wide variety of health care needs. Thus, a single male in excellent health, without any dependents, may tolerate an average quality health care plan at a low monthly cost. In contrast, a married individual with young dependent children and a spouse who does not have health benefits offered through an employer may prefer a relatively high quality health care plan, despite any higher monthly cost. Individuals who have existing ailments, are planning a family or have a family history of certain ailments may also require a relatively high quality health care plan, despite any higher monthly cost.

Preferably, each page of inquiries includes two columns, as shown in FIGS. 7 through 9. The left column lists questions for the user. The right column lists available plans, sorted by cumulative total score (as discussed below). The initial page of inquiries, as shown in FIG. 7, may list the plans in any order (e.g., alphabetical or random) because scores have not yet been computed.

A database 230 includes, for each health plan, the cost to the user, benefits available, eligibility criteria, accreditation information and performance measures. The performance measures are ratings for each attribute for each plan. The ratings are related to the answers to the inquiries. Assuming there are three possible answers for each question (e.g., “I require above average quality,” “I can accept average quality” or “This measure doesn't matter”), then the rating for each attribute may be translated into a score on a three-part scale: above average (relative to the other available plans), average (relative to the other available plans), or below average (relative to the other available plans). The plan's score will reflect not only how it performed relative to other plans, but also whether the plan met the user's threshold for that attribute's importance.

Raw data, from which ratings are determined, may come from various sources. Preferably, independent third party data is used to determine a rating for each attribute of each plan.

One preferred source of data known in the art is the CAHPS® database. The Agency for Health Care Policy and Research (AHCPR), which was reauthorized on Dec. 6, 1999, as the Agency for Healthcare Research and Quality (AHRQ) <www.ahrq.gov>, a public health service agency in the Department of Health and Human Services (HHS) reporting to the HHS Secretary, has spearheaded a project known as the Consumer Assessment of Health Plans (CAHPS®) to help consumers identify the best health care plans and services for their needs. AHRQ efforts have included the development of questionnaires that assess health plans and services from the consumer's perspective. The National CAHPS® Benchmarking Database (NCBD), a repository for CAHPS® survey results, facilitates comparisons of CAHPS® results. The NCBD, which is administered by Shaller Consulting and Westat, may be accessed through <http://ncbd.cahps.org/>.

To illustrate, hypothetical year 2000 scores for plans R, G and M for the CAHPS measure “Customer Service” (a composite score including the proportion of enrolled respondents who had a problem getting information from the plan's written materials, getting help from customer service, or getting paperwork processed) were 48%, 41.8% and 35%, respectively. Based on these CAHPS ratings, plan R may be considered significantly worse than the average for all plans (39.6%) at the α=0.05 level (i.e., a 95% confidence level), and given a “below average” rating for the attribute; plan G may be considered not significantly different from the average, and given an “average” rating for the attribute, and plan M may be considered significantly better than average, and given an “above average” rating for the attribute.

Another preferred source of data known in the art is the Health Plan Employer Data and Information Set (HEDIS®) available from the National Committee for Quality Assurance (NCQA) <www.ncqa.org>. HEDIS® uses various types of quality measures, including clinical performance measures based on information such as members' medical records. These measures help to compare how well plans prevent and treat illness. For example, one HEDIS® measure looks at how many adult smokers or recent quitters were advised to quit by a health professional in the plan. Another looks at whether two-year-olds are up to date on recommended shots. Some other HEDIS® measures look at breast cancer screening, controlling cholesterol, prenatal care, and at eye exams to prevent blindness in people with diabetes.

To illustrate, hypothetical year 2000 scores for plans R, G and M for the HEDIS® measure “Breast Cancer Screening Rate” (the percentage of women between the ages of 52-69 continuously enrolled for the past two years who had a mammogram during that period) were 86.2%, 61.6% and 78.4%, respectively. Plan R may be considered significantly better than the average for all plans (76.5%) at the α=0.05 level, and given an “above average” rating for the attribute; plan G may be considered significantly worse than average, and given a “below average” rating for the attribute; and plan M may be considered average, and given an “average” rating.

Other preferred sources of data include various accreditation programs for health plans. Typically, such accreditations are awarded in distinct levels ranging from full accreditation or excellent to denied. The goal of the various accreditation programs is the same; in each case, to conduct an independent review against a set of standards and, based on that review, make an accreditation determination to inform consumers' and employers' enrollment or contracting decisions. The standards are typically designed to evaluate a health plan's clinical and administrative systems related to such issues as consumer protection, confidentiality and customer service, as well as a plan's clinical performance. The NCQA operates one such preferred accreditation program. The Joint Commission on Accreditation of Healthcare Organizations (JCAHO) <www.jchao.org>also operates an accreditation program known in the art.

To illustrate, year 2000 NCQA accreditation status for plans R, G and M, may be: Met Only Some Standards/Did Not Go Through Accreditation Process; Met Only Some Standards/Did Not Go Through Accreditation Process; and Excellent/Commendable, respectively. This may translate into “below average” ratings for R, and G on this measure, and an “above average” rating for M on this measure. Any plan that achieved a status of Accredited may be rated as “average” on this measure.

For an implementation of the present invention that facilitates the selection of health care providers, various other sources of data may be used. For example, the California Office of Statewide Health Planning and Development (OSHPD) provides two sources of data. The California Hospital Outcomes Project reports risk-adjusted mortality rates by hospital for acute myocardial infarction patients, intensive care units, hip fracture patients and pneumonia patients. The California Coronary Artery Bypass Graft (CABG) Mortality Reporting Program, a joint effort of OSHPD and the Pacific Business Group on Health, reports risk-adjusted CABG mortality rates by hospital. The New York State Department of Health has two reports on risk-adjusted mortality rates not only by hospital, but also by physician: Coronary Artery Bypass Surgery in New York State, and Percutaneous Coronary Interventions in New York State. The Pennsylvania Health Care Cost Containment Council's report, Pennsylvania Guide to Coronary Artery Bypass Graft Surgery, provides risk-adjusted mortality rates by hospital and by surgeon. Additional criteria that may be used to distinguish and narrow the choices of available health care providers include: participation in the user's health plan, training and board certification in a selected area of specialty, office location and office hours.

After a user responds to a page of inquiries, each plan is scored based on each response. In a preferred implementation, three assumptions underlie scoring: (1) all health plans are initially equally desirable to a potential enrollee; (2) no potential enrollee will desire a below-average health plan; and (3) a potential enrollee who finds an average health plan acceptable will find an above average health plan more acceptable. Based on the first assumption, each plan initially has a score of zero. Scores are determined by comparing user responses with the ratings for each attribute stored in the database 230 and then adjusting the cumulative scores according to scoring rules 225. Preferred scoring rules for responses that include three possible choices are:

1. If a user specifies that “This measure doesn't matter” (or the like) for a particular attribute, then no health plan scores change.

2. If a user specifies that “I can accept average quality” (or the like) for a particular attribute, then the scores of available health plans rated above average are increased by one (1), the scores of available health plans rated average do not change, and the scores of available health plans rated below average are decreased by one (1).

3. If a user specifies that “I require above average quality” (or the like) for a particular attribute, then the scores of available health plans rated above average do not change, the scores of available health plans rated average are decreased by one (1), and the scores of available health plans rated below average are decreased by two (2).

To illustrate scoring, referring to the example provided above for the CAHPS measure “Customer Service” for plans R, G and M, a user's response to an inquiry concerning the measure (e.g., the Medical Plan Customer Service inquiry as shown in FIG. 7) may indicate that the user wants a plan that is considered at least average on this measure. Applying the foregoing scoring rules, plan R's composite score would lose one point, plan G's score would not change, and plan M's score would increase by 1.

To further illustrate, referring to the example provided above for the HEDIS measure “Breast Cancer Screening Rate” for plans R, G and M, a user's response to a Breast Cancer Screening Rate inquiry concerning the measure may indicate that the user wants a plan that is considered at least average on this measure. Applying the foregoing scoring rules, plan R's composite score would gain one point, plan G's score would lose one point, and plan M's score would not change.

Other scoring rules representative of the relative desirability of a plan's attributes based on user-expressed preferences may be employed. For example, scoring rules that increase or decrease scores by amounts that are different than the amounts set forth above, such as multiples or fractions of the amounts set forth above, may be used, and clearly and come within the scope of the present invention. Scoring rules may also disqualify available plans that do not have ratings for certain attributes that are acceptable to a user. Likewise, scoring rules that adjust scores to account for more than three possible responses per question may be used, and come within the scope of the present invention.

Referring again to FIG. 7, and steps 220 through 240 of FIG. 2, after entering responses to the inquiries, a user may select a continue button to proceed. Next, the system will update the cumulative score for each plan 225 by comparing user responses to the ratings for each attribute stored in the database 230 and then adjusting the cumulative scores according to the foregoing scoring rules 225. The user may then be presented additional inquiries (as in steps 240 and 220) on a split screen, along with a listing of the available plans sorted (as in step 235) according to their cumulative scores, as shown in FIG. 8. Again, after entering responses to the inquiries, a user may select a continue button to proceed. The sequence of updating the cumulative scores, sorting and presenting new inquiries preferably repeats (as in FIGS. 9 through 11) until the user has responded to all inquiries.

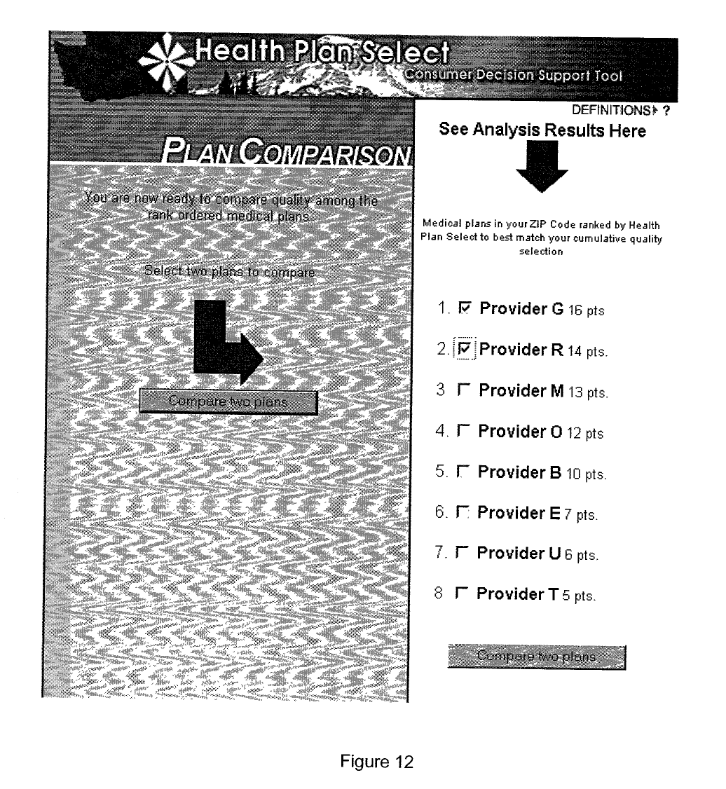

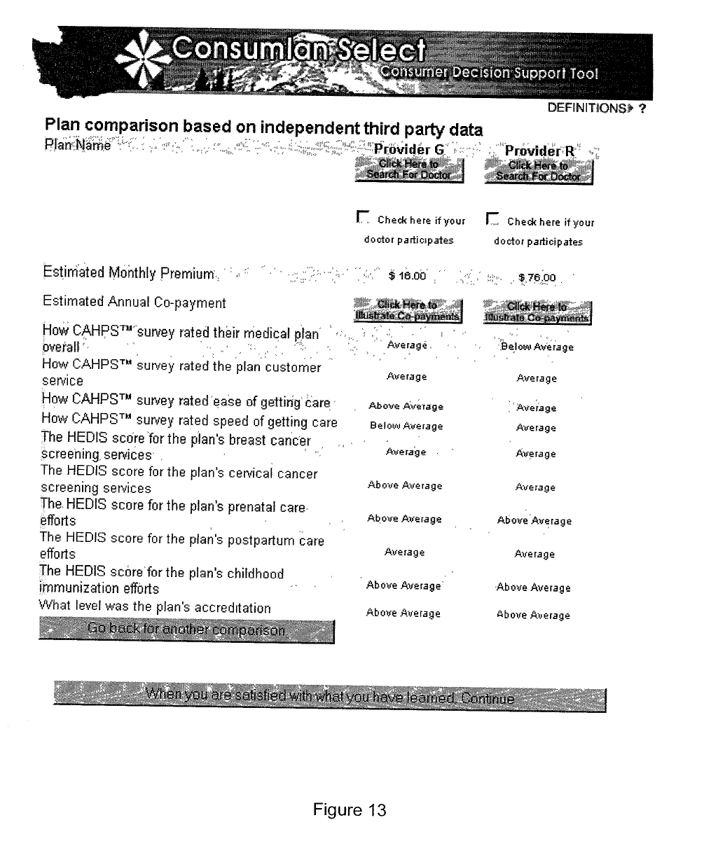

After responding to all inquiries, the user may be presented plan comparison options, as in steps 245 to 270, including a listing of the available plans sorted (as in step 235) according to their cumulative scores, as shown in FIG. 12. The user may then select plans to compare, as in step 245, side-by-side according to cost, cumulative scores and ratings for each attribute of each plan, as in step 255 and as shown in FIG. 13. The comparison screen preferably provides links to explanatory information as well as to a searching tool and/or listing of physicians under a plan. The comparison screen preferably also provides a link to co-payment comparison steps based on predicted usage and estimated co-payments. The comparison process may be repeated as desired, as in steps 245 through 270. While FIGS. 12 and 13 limit comparisons to two (2) plans at a time, which is considered a manageable amount of data and consumes a considerable portion of a typical computer screen when displayed, comparisons may include more than two (2) plans at a time.

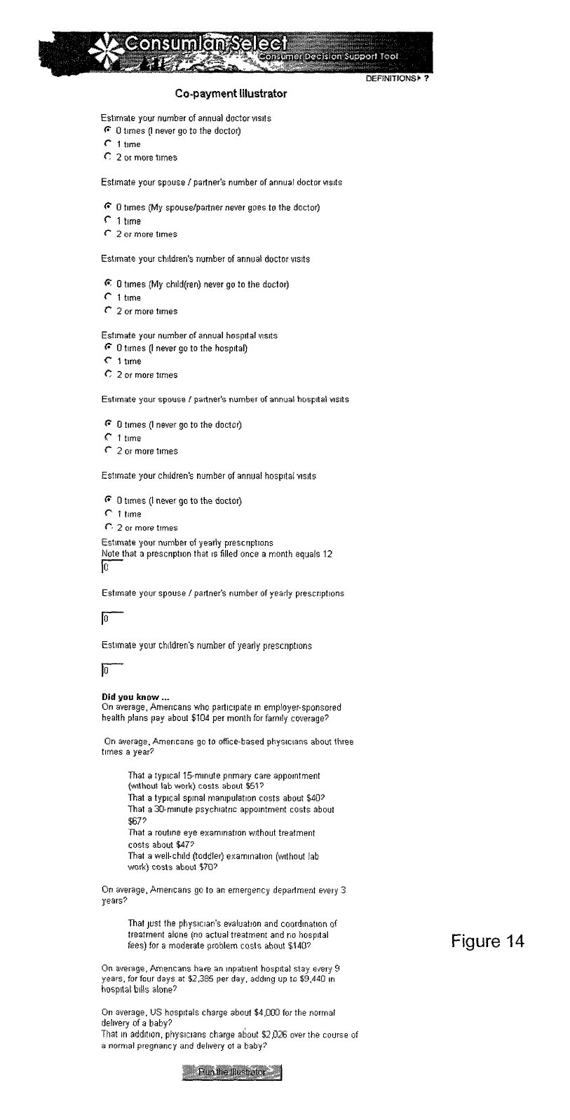

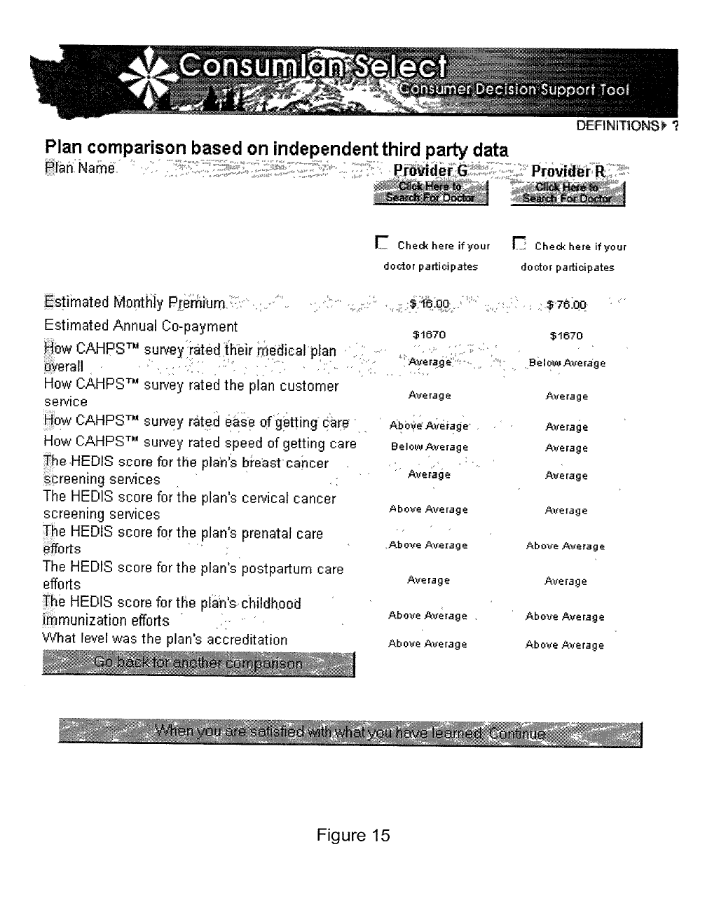

The co-payment comparison steps, included in steps 260 and 265, estimate annual co-payments based on predicted usage. To illustrate, upon selecting the icon entitled “Click Here to Illustrate Co-payments” in FIG. 13, a user may be presented with a screen of questions concerning estimated doctor visits, hospital visits and prescriptions, as in FIG. 14. These variables are principal co-payment drivers. Applying each plan's co-payment rules (e.g., $10/doctor's visit, $20/hospital visit and $5/prescription filled), an estimated annual co-payment may be computed for each plan and presented, as in FIG. 15.

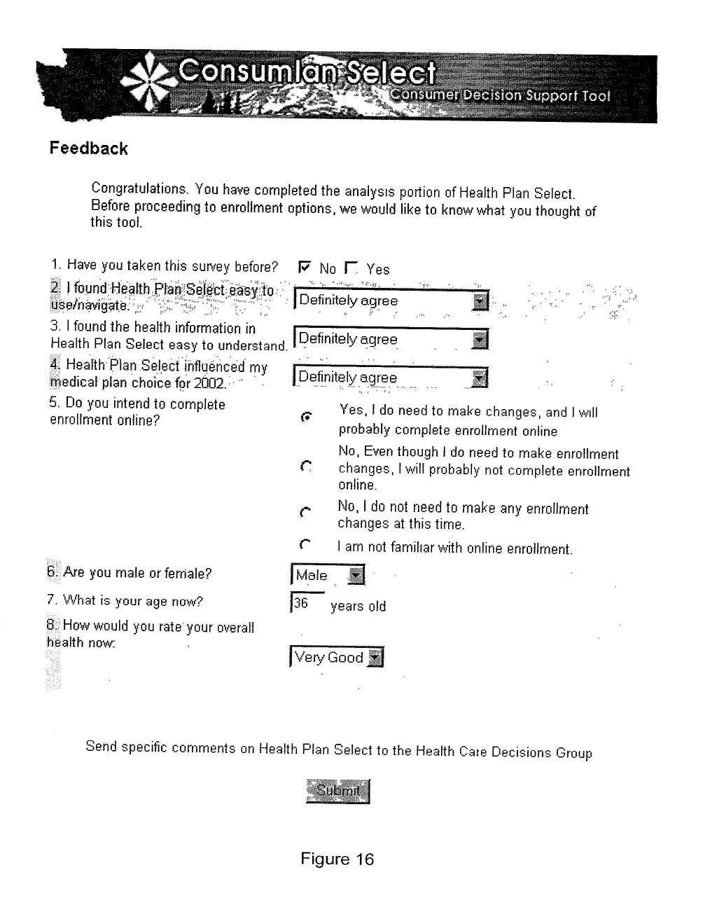

After completing comparisons, a user may be presented with a survey screen, as in step 275 and as shown in FIG. 16. The survey screen may solicit suggestions and information concerning the user's experience in using the selection system and methodology, as well as demographics. The information may be used to refine a particular implementation of the methodology and system of the present invention.

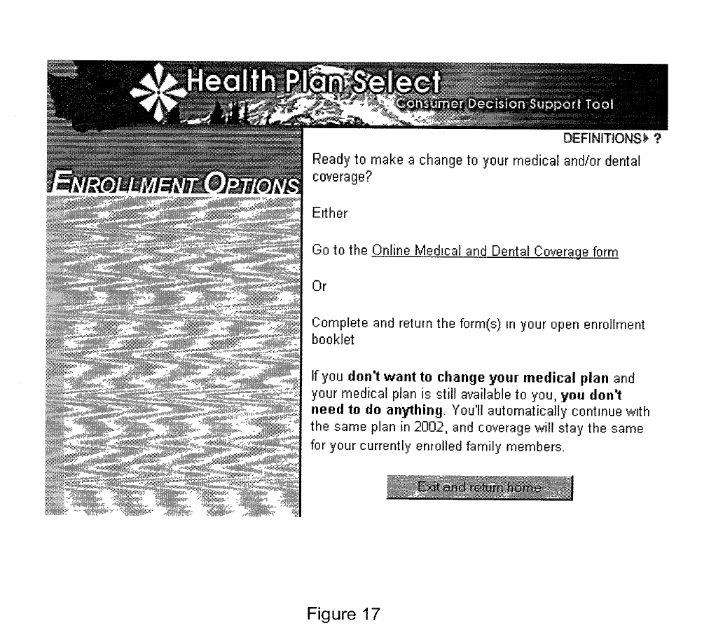

Next, a user may be presented with a screen providing links to on-line signup, as in step 280 and as shown in FIG. 17. Should the user wish to change his or her health plan benefits, he or she preferably may do so online, as in step 285.

The invention defined below by the enumerated claims may be better understood by referring to the above detailed description, which should be read in conjunction with the accompanying drawings. This detailed description of a particular preferred embodiment, set out above to enable one to practice the invention, is not intended to limit the enumerated claims, but to serve as a particular example thereof. Those skilled in the art should appreciate that they can readily use the concepts and specific implementations disclosed as a basis for modifying or designing other methods and systems for carrying out the same purposes of the present invention. Those skilled in the art should also realize that such equivalent methods and systems do not depart from the spirit and scope of the invention in its broadest form.

We claim:

1. A method of facilitating a user's selection of a health plan from a plurality of available health plans, said method comprising steps of:
a. providing a rating for each of a plurality of attributes for each health plan of the plurality of available health plans;
b. determining the relative importance of each of the plurality of attributes to the user; and
c. computing a score for each health plan of the plurality of available health plans based on the relative importance of each of the plurality of attributes to the user in comparison to the rating for each of the plurality of attributes of each health plan of the plurality of available health plans, said score being computed according to scoring rules.

2. The method according to claim 1, wherein the rating for each of a plurality of attributes for each health plan of the plurality of available health plans is a rating from the group consisting of:
a. an above average rating,
b. an average rating, and
c. a below average rating.

3. The method according to claim 2, wherein the relative importance of each of the plurality of attributes to the user is a measure of relative importance from the group consisting of:
a. an above average importance,
b. an average importance, and
c. a below average importance.

4. The method according to claim 3, wherein the scoring rules include:
a. assigning each health plan a starting score,
b. for each attribute having a below average relative importance, maintaining the score of each health plan for the attribute,
c. for each attribute having an average relative importance,
i. increasing by a first determined amount the score of each health plan having a rating of above average for the attribute,
ii. maintaining the score of each health plan having a rating of average for the attribute, and
iii. decreasing by a second determined amount the score of each health plan having a rating of below average for the attribute; and
d. for each attribute having an above average relative importance,
i. maintaining the score of each health plan having a rating of above average for the attribute,
ii. decreasing by a third determined amount the score of each health plan having a rating of average for the attribute, and
iii. decreasing by a fourth determined amount the score of each health plan having a rating of below average for the attribute.

5. The method according to claim 4 wherein the first determined amount equals the second determined amount, and the second determined amount equals the third determined amount, and the third determined amount is less than the fourth determined amount.

6. The method according to claim 5, said method further including a step of sorting the plurality of available health plans according to the score computed for each of the plurality of available health plans.

7. The method according to claim 6, said method further including a step of calculating estimated total co-payment amounts for a determined period of time for at least two health plans from the plurality of available health plans.

8. The method according to claim 7, wherein the step of calculating estimated total co-payment amounts further includes a step of requesting the user to provide estimates of a number of doctor visits, a number of hospital visits and a number of prescriptions filled.

9. The method according to claim 8, said method further including a step of displaying the rating for each of the plurality of attributes for at least two health plans from the plurality of available health plans.

10. The method according to claim 9, said method further including a step of providing online enrollment for a plan from the plurality of available health plans.

11. A method of facilitating a user's selection of a health care provider from a plurality of available health care providers, said method comprising steps of:
a. providing a rating for each of a plurality of attributes for each health care provider of the plurality of available health care providers;
b. determining the relative importance of each of the plurality of attributes to the user; and
c. computing a score for each health care provider of the plurality of available health care providers based on the relative importance of each of the plurality of attributes to the user in comparison to the rating for each of the plurality of attributes of each health care provider of the plurality of available health care providers, said score being computed according to scoring rules.

12. The method according to claim 11, wherein the rating for each of a plurality of attributes for each health care provider of the plurality of available health care providers is a rating from the group consisting of:
a. an above average rating,
b. an average rating, and
c. a below average rating.

13. The method according to claim 12, wherein the relative importance of each of the plurality of attributes to the user is a measure of relative importance from the group consisting of:
a. an above average importance,
b. an average importance, and
c. a below average importance.

14. The method according to claim 13, wherein the scoring rules include:
a. assigning each health care provider a starting score,
b. for each attribute having a below average relative importance, maintaining the score of each health care provider for the attribute,
c. for each attribute having an average relative importance,
i. increasing by a first determined amount the score of each health care provider having a rating of above average for the attribute,
ii. maintaining the score of each health care provider having a rating of average for the attribute, and
iii. decreasing by a second determined amount the score of each health care provider having a rating of below average for the attribute; and
d. for each attribute having an above average relative importance,
i. maintaining the score of each health care provider having a rating of above average for the attribute,
ii. decreasing by a third determined amount the score of each health care provider having a rating of average for the attribute, and
iii. decreasing by a fourth determined amount the score of each health care provider having a rating of below average for the attribute.

15. The method according to claim 14 wherein the first determined amount equals the second determined amount, and the second determined amount equals the third determined amount, and the third determined amount is less than the fourth determined amount.

16. The method according to claim 15, said method further including a step of sorting the plurality of available health care providers according to the score computed for each of the plurality of available health care providers.

17. A computer implemented system for facilitating a user's selection of a health plan from a plurality of available health plans, said system comprising:
a. a database including a rating for each of a plurality of attributes for each health plan of the plurality of available health plans;
b. means for determining the relative importance of each of the plurality of attributes to the user; and
c. means for computing a score for each health plan of the plurality of available health plans based on the relative importance of each of the plurality of attributes to the user in comparison to the rating for each of the plurality of attributes of each health plan of the plurality of available health plans, said score being computed according to scoring rules.

18. The system according to claim 17, wherein the rating for each of a plurality of attributes for each health plan of the plurality of available health plans is a rating from the group consisting of:
a. an above average rating,
b. an average rating, and
c. a below average rating.

19. The system according to claim 18, wherein the relative importance of each of the plurality of attributes to the user is a measure of relative importance from the group consisting of:
a. an above average importance,
b. an average importance, and
c. a below average importance.

20. The method according to claim 19, wherein the scoring rules include:
a. assigning each health plan a starting score,
b. for each attribute having a below average relative importance, maintaining the score of each health plan for the attribute,
c. for each attribute having an average relative importance,
i. increasing by a first determined amount the score of each health plan having a rating of above average for the attribute,
ii. maintaining the score of each health plan having a rating of average for the attribute, and
iii. decreasing by a second determined amount the score of each health plan having a rating of below average for the attribute; and
d. for each attribute having an above average relative importance,
i. maintaining the score of each health plan having a rating of above average for the attribute,
ii. decreasing by a third determined amount the score of each health plan having a rating of average for the attribute, and
iii. decreasing by a fourth determined amount the score of each health plan having a rating of below average for the attribute.
